(19) United States
(12) Patent Application Publication
(10) Pub. No.: US 2003/0024877 A1
(43) Pub. Date: Feb. 6, 2003

(54) Cell concentrator and washer

(76) Inventors: Rupert P. Amann, Ft. Collins, CO (US); Roy H. Hammerstedt, Boalsburg, PA (US)

Correspondence Address: Barbara E. Johnson, Webb Ziesenheim Logsdon Orkin & Hanson, 700 Koppers Building, 436 Seventh Avenue, Pittsburgh, PA, 15219, US

(21) Appl. No.: 10/044,822

(22) Filed: Jan. 10, 2002

Related U.S. Application Data
(60) Provisional application No. 60/260,730, filed on Jan. 10, 2001.

(51) Int. Cl. B01D 11/00

(52) U.S. Cl. 210/634; 210/644; 210/321.6; 210/511

(57) ABSTRACT

A device allowing rapid and gentle concentration of cells at essentially unit gravity using solvent flow, under hydrostatic pressures equivalent to as little as ≦1 cm of water, through capillary-pore walls, more or less vertical, of a construct serving as both the separation device and receptacle for accumulating cells. The device can be used in a batch or continuous mode. The device contains a solid lower end fabricated with a shape to facilitate collection of the desired cells in an appropriate volume, and a more or less vertical active wall, extending upward from the solid lower end and providing an appropriate surface area with pores having a diameter appropriate for retention of the desired cells and outward passage of all smaller cells or solvent.

### CROSS REFERENCE TO RELATED APPLICATION

This patent application claims priority to U.S. Provisional Patent Application Serial No. 60/260,730, filed Jan. 10, 2001.

### BACKGROUND OF THE INVENTION

1. Field of the Invention

This invention relates to separation technology, including membranology, and concentration of cells or particles in a suspension, essentially at unit gravity, by transfer of fluid, but not desired cells or particles, through a more or less vertical separation membrane.

2. Description of the Related Art

Frequently in biology, other sciences, or manufacturing, it is desirable to concentrate cells or particles from a dilute suspension to a small volume to facilitate further use, washing or analysis. Cells usually are concentrated via sedimentation, followed by aspiration of fluid depleted of cells but often containing many residual cells. Separation by sedimentation depends on cell density and/or size differences between cells of interest and solvent or contaminating cells. Simple sedimentation at unit gravity can be time consuming, gives imperfect separation, and frequently provides recovery of <90% of the cells in the original suspension. Sedimentation at increased pressure or gravitational force (e.g., centrifugation), without or through a separation medium (e.g., sucrose or colloidal silica), often damages the cells, and retains the disadvantages of simple sedimentation. These limitations are not eliminated by counter-streaming centrifugation. Similarly, cells can be concentrated by placing a suspension on the membrane of a cup-like device and exerting negative pressure (i.e., a vacuum) on the lower face of a more or less horizontal membrane or positive pressure on the suspension of cells. Such devices can be rapid, but the membrane might become plugged before all cells are harvested and cells contacting the membrane might be damaged. It is difficult to avoid removing all solvent, and recovery and resuspension of most cells without damage is difficult.

Occasionally, a dialysis chamber is used to wash cells, although this approach is impractical to concentrate a cell suspension. However, concentration of solutes by ultrafiltration is widely used. We and others have attempted to use commercially available devices with a bundle of ultrafiltration capillaries within a chamber to remove solvent and, thus, concentrate cells in a suspension. This approach proved impractical because the ultrafiltration membranes rapidly become clogged and because it was impossible to recover the majority of cells in the starting suspension. Use of filters, especially plastic mesh or metal mesh filters with mesh openings ≧20 micrometers across, is common in cell biology and particle or seed analysis. Such filters conventionally are flat or formed into a boat-like or conical shape by the user, and because of the mesh size and composition can have a rapid flow rate while retaining relatively large cells (e.g., an ovum). Because of mesh size and dimension of the openings, they are of no use with small cells (e.g., spermatozoa) or chromosomes.

In theory, membrane filters rather than mesh filters could be used to harvest cells of interest. In practice, membrane filters are used only to concentrate and to harvest cells for analysis; previously they have been impractical for concentrating cells in a suspension with minimal damage. This is because cells are spread across a relatively large surface, tend to occlude the membrane, and are not concentrated in a small retained volume. Hence, recovery of cells from a mesh or membrane filter requires mechanical scraping or back washing; the first two damage cells and the latter provides a dilute suspension. Regardless, many cells are lost or damaged.

Accordingly, an object of the present invention is to provide a means for concentrating or washing cells without subjecting them to mechanical action, increased pressure, increased gravitation or back washing. It is also an object of the present invention to provide a means for concentrating or washing cells in which the filter used contains pores of a uniform size, has a usable flow rate, is resistant to clogging and retains essentially all of the cells of interest in the original suspension.

### SUMMARY OF THE INVENTION

The present invention is a cell concentrator having an inner vessel with a solid lower end and an active wall, with an interior surface and an exterior surface, extending upward from the solid lower end. Pores passing through the active wall are configured to facilitate liquid flow through the active wall. The pores are configured by coating the pore surfaces with, or occluding the pores with, a substance that expedites the passage of fluid through the pore. The coating or occluding material used to configure the membrane may produce enhanced wettability, reduced surface tension, or other surface effects. Occluding substances are selected to erode or dissolve in contact with the working fluid; the erosion may be triggered by environmental conditions such as solvent concentration, ionic conditions, temperature, or pH. The active wall is typically a capillary-pore membrane bonded to a porous supporting material.

The cell concentrator of the present invention may be used to concentrate cells by placing a suspension containing solvent and cells into the interior of the inner vessel, allowing solvent to pass through the active wall, and removing the suspension from the interior vessel when a desired concentration is achieved. The cell concentrator also may be used to wash cells by placing a suspension containing solvent and cells into the interior of the inner vessel, adding a cleaning solution to the interior of the inner vessel, allowing cleaning solution and solvent to pass through the active wall, and removing resultant suspension of cells, now in the cleaning solution, from the interior of the inner vessel when washing is accomplished.

### BRIEF DESCRIPTION OF THE DRAWINGS

FIG. 1 is a vertical sectional view of the present invention;

FIG. 2 is a vertical sectional view of the present invention;

FIG. 3 is an external side view and a horizontal sectional view of the present invention; and

FIG. 4 is a vertical sectional view of the present invention.

### DESCRIPTION OF THE PREFERRED EMBODIMENTS

Definitions

“Cell”—In this disclosure, we use the term “cell” in a generic sense, to include any living or dead cell, subcellular component, chromosome, or particle of any composition. The device disclosed herein is not limited by interpretation of the term cell. In the description of this invention we use only the term cells, and all examples are based on cells, but it could similarly read, or show examples, for concentration of particles.

“Particle”—In this disclosure, we use the term “particle” in a generic sense, to include any inorganic or organic, nonliving, particle of a size that could be usefully concentrated using the devices described herein. The device disclosed herein is not limited by interpretation of the term particle.

“Fibril membrane”—A membrane with a “haystack” structure, where limits to a separation are accomplished by the effective diameters of the tortuous passageways of varying size through a crisscrossed bed of filter materials constituting the filter.

“Microporous membrane”—A membrane with a “sponge-like” structure, with tortuous pores of varying size created during manufacture, where limits to a separation are accomplished by the effective diameters of the tortuous passageways through the sponge-like filter.

“Capillary-pore or track-etched membrane”—A membrane with smooth faces with “tunnel” structures, created in a solid sheet of base membrane material during manufacture and characterized by pores of uniform diameter through the membrane. Limits to a separation are accomplished by diameters and uniformity of the pores through the base material.

“Active wall”—A portion of a construct consisting of a piece of capillary-pore, or other, membrane, providing a more or less vertical wall with pores appropriate for retention of the desired cells or particles and outward passage of smaller cells, particles, solutes or solvent. Although the preferred construct uses an active wall fabricated from a capillary-pore membrane and positions the active wall at an angle between 70° and 110° to horizontal, the device disclosed herein is not limited by the type of membrane used or the exact orientation of the active face.

“Solid lower end”—A portion of a construct positioned below, or around, an active wall. A solid lower end has no pores or pathway for outflow of cells, particles, medium, or solvent, and is either flat or fabricated to a shape to facilitate collection of cells or particles in a desired volume of medium or solvent. Although the preferred solid lower end is fabricated from plastic and bonded to the active wall by techniques known to those skilled in the art, the device disclosed herein is not limited by either the material used to fabricate the solid lower end or the method to assemble the complete construct.

“Solid-upper wall”—An optional portion of a construct positioned above or partly inside an active wall. A solid upper-wall has no pores or pathway for outflow of cells, particles, medium, or solvent, and is fabricated to a shape to facilitate placement of cells or particles into the construct, or to increase the capacity of the construct. Although the preferred solid-upper wall is fabricated from plastic, and might be bonded to the active wall by techniques known to those skilled in the art, the device disclosed herein is not limited by either the material used to fabricate the solid-upper wall or the method to assemble the complete construct.

“Extender”, “Buffer”, “Medium”, and “Solvent”—All are terms used to describe the material in which cells or particles are suspended before and after passage through devices as disclosed herein. The terms are used as conventionally used by those working with particular cells or particles. Although the preferred material is water-based, the device disclosed herein is equally useful with mixtures or organic solvents, compatible with the device, as the material suspending the cells or particles.

“Surface active agent”—A generic term for a material(s) that preferentially absorbs at interfaces as a result of the presence of both lyophillic and lyophobic structural units, with said absorption generally resulting in alteration of surface or interfacial properties of the system.

“Surface tension”—The property of a liquid evidenced by the apparent presence of a thin elastic membrane along the interface between liquid and vapor phase, resulting in a contraction of the interface and reduction of the total interfacial area. Thermodynamically, surface tension is the excess free energy per unit area of interface resulting from an imbalance in the cohesive forces acting on liquid molecules at the surface.

“Contact angle”—The angle formed between a solid surface and the tangent to a liquid drop on that surface at the line of contact between the liquid, the solid, and the surrounding phase (usually vapor or air), measured through the liquid.

“Configured”—With respect to the pores disclosed herein, the term “configured” is used to indicate that either the pore surface is coated with, or the pore is occluded with, a substance that expedites the passage of fluid through the pore. The coating or occluding material used to configure the membrane may produce enhanced wettability, reduced surface tension, or other surface effects. Occluding substances are selected to erode or dissolve in contact with the working fluid; the erosion may be triggered by environmental conditions such as solvent concentration, ionic conditions, temperature, or pH.

Membrane filters can be prepared from many different polymers, as well as ceramic or metal. Materials that may be used include cellulose, cellulose esters, nitrocellulose, polyvinylidene difluoride, polytetrafluoroethylene, nylon, polyethylene, polypropylene, polycarbonate, polyester, as in Mylar film, and silver. All membrane filters have one of three physical forms.

1. Fibril membranes have a “haystack” structure, where limits to a separation are accomplished by tortuous passageways of varying size through a crisscrossed bed of filter materials.

2. Microporous membranes have a “sponge-like” structure, where tortuous pores of varying size are created, with proprietary procedures possibly involving gas extrusion and other mechanisms, during formation of the base membrane material.

3. Capillary-pore or track-etched membranes have two smooth surfaces penetrated by “tunnel-like” pores, each with a smooth interior surface, created in a solid sheet of base membrane material by inducing highly controlled physical damage in the membrane and then etching the damaged areas to create pores of uniform diameter through the membrane.

Typically, microporous or capillary-pore membranes have been used in devices used to filter cell suspensions for analysis as described above.

There are two important distinctions between a microporous membrane and a capillary-pore membrane, as illustrated in published product literature. These are, respectively, a sponge-like vs. a smooth surface and low vs. high uniformity in pore diameter. One vendor (Millipore Inc.) provides illustrations and notes that in their microporous membranes the passageways have a range in diameters. It is stated that their 10-micrometer pore product has approximately 68% passageways of nominal 10 micrometer diameter (range not known), but approximately 32% passageways substantially smaller than the nominal 10 micrometers. In contrast, one vendor of capillary-pore membranes (Oxyphen AG) provides illustrations and states that the tunnel-like pores are of uniform diameter throughout their length and all are within ±10% of the stated diameter. Hence, capillary-pore membranes should have more accurate and precise discrimination for size of cells to be retained and trap fewer cells in/on the membrane, and are therefore preferred for use in this invention. As known to those skilled in the art, however, cells can be sticky when in certain media or when contacting certain surfaces and this can affect recovery of cells from any container. Cell concentrators with pores having diameters within ±15% or preferably ±10% of the stated diameter are preferred for use in this invention. For certain procedures, cell concentrators with pores having a uniformly tapered shape as the pores progress from the interior surface to the exterior surface are preferred. The larger pore diameter may be either near the interior surface or near the exterior surface.

Inherent to manufacture of capillary-pore membranes is extensive introduction of charges on the face of the tunnel or passageway, with minimal formation of charges on the general polymer faces. This is because capillary-pore membranes are produced by physically damaging polymer film in a controlled manner with a beam of heavy ions (e.g., krypton) in a cyclotron. The ions follow a linear path where interaction with polymer chains of the membrane releases energy to damage molecules in the polymer matrix. Damage represents latent pores, which subsequently are opened by chemical etching (e.g., cycles of alkaline and acid treatment) to form tunnel-like transmembrane pores. Specifically, carboxyl functions are formed during the etching. This fact, the tunnel-like nature of capillary pores, and surface tension of an aqueous suspension usually prevent or minimize flow of water, or similar solvents, through a capillary-pore membrane (especially if the pores are ≦5 micrometers in diameter) unless pressure is applied via a hydrostatic head, air or piston pressure, vacuum, or gravitational force. However, a stock capillary-pore membrane to be used in the present invention can be configured to fill the tunnel-like pores with an appropriate material, as disclosed in U.S. Pat. No 5,261,870, incorporated herein by reference. Such configuration provides a convenient approach to obtain transmembrane flow of water, or similar solvent, with minimal pressure and can concurrently control when flow of solvent through the membrane will commence. The material occluding the membrane in this embodiment erodes or is dissolved in contact with working fluid. This erosion or dissolution expedites passage of fluid through the pore.

Examples of materials that may be used in the present invention to configure the membrane and occlude pores include, but are not limited to, cellulosics (i.e., methylcellulose, carboxymethylcellulose, hydroxypropylmethylcellulose, ethylcellulose, etc.), polyvinylpyrrolidone or polyvinylalcohol polymers, polysaccharide crystals, surfactants, or other materials known in the membraneology arts. Alternatively, the interior surfaces of the tunnel-like pores may also, or may alternatively, be configured by coating with a surfactant such as a detergent or amyl alcohol. Such configuration of the membrane may be beneficial regardless of pore diameter (i.e., 0.01 to >15 micrometers), but is especially useful when the pores have diameters within the preferred range of approximately 0.03 to approximately 5 micrometers, or within the range of approximately 5 micrometers to approximately 20 micrometers.

Several manufacturers provide “centrifugal concentrators” (e.g., as taught in U.S. Pat. Nos. 4,632,761 and 4,832,851) which are a centrifuge tube or bottle with an insert in which the bottom of the insert is a microporous membrane with (in 2000-2001 catalogues) nominal pore sizes of 0.2 or 0.45 micrometers, or an ultrafiltration membrane; the membrane is perpendicular to the gravitational force. Typically, these devices are used to filter solutions prior to analysis, with the retentate discarded, or to concentrate solutes via ultrafiltration, with the retentate removed for use. Although such devices can accommodate from <1 to 60 milliliters in a batch mode of operation, they require centrifugation and cannot be operated conveniently in a continuous mode. None of these devices uses a capillary-pore membrane, and all require centrifugation, providing a force >100 times gravity, to move solvent through the membrane to allow concentration of solutes.

Use of such devices to concentrate cells is not described in catalogue descriptions, product literature, or in web sites (e.g., that of Millipore Corporation). This probably is because use of conventional centrifugal devices fabricated with membranes having a nominal pore diameter of 0.45, 0.8, 1, or 5 micrometers, could not be used to concentrate cells because the sedimenting cells would plug the pores of the membrane before most fluid passed out. Even if available, centrifugal devices of the most customary designs and with pores between 0.45 micrometers and 20 micrometers nominal diameter could not be used to concentrate or wash cells because the membrane face is perpendicular to the substantial gravitational force.

The concept of placing the membrane face of a centrifugal concentrator parallel to the gravitational force also has been described (e.g., U.S. Pat. Nos. 5,112,484 and 5,647,990). At least one vendor lists such a centrifugal device with a membrane parallel to gravitational force, with the membrane having 30 micrometer pores.

The fact that available filtration devices of this general type, with the membrane either perpendicular to or parallel with the direction of applied force vector, are designed for use only in a centrifuge is strong evidence that manufactures considered flow rates through these devices at unit gravity to be far too slow for any practical use, and possibly recognize that recovery of viable cells might be a problem.

Lack of utility of such centrifugal devices for concentration or washing of cells likely is because these devices use a microporous rather than capillary-pore membrane, require pressure greater than a few centimeters of water to initiate flow through the membrane, and usually position the membrane perpendicular to the direction of cell movement due to gravitational force rather than more or less parallel to the direction of cell movement due to gravitational force.

A medical diagnostic device has been described (U.S. Pat. No. 5,160,704) which uses capillary action or suction, rather than centrifugal force, to move fluid through an absorbent filter element. Cells or particles are retained on or behind the filter. In these devices, the filter is formed from highly absorbent fibrous material with the fibers aligned more or less parallel. The design and use of this device might facilitate diagnostic pathology, but U.S. Pat. No. 5,160,704 describes a device very different from that disclosed herein.

Devices such as those disclosed herein, which can operate in the absence of centrifugal force, capillary action and suction, have many uses in cell biology. They can be used to concentrate cells or particles, to separate cells or particles in one sub-population from those of another sub-population differing in size, or to wash cells. They can be used in a continuous or batch mode. As an example of the former, the technique of fluorescence-activated cell sorting can be used to isolate cells of a desired type based on intrinsic properties (e.g., DNA mass) or additions (permeable dyes or labeled antibodies), but such cells accumulate over time in a dilute suspension. Currently cells are accumulated in a tube over time (e.g., 0.05 to 5 hours) while cells remain at low concentration, which often is undesirable, and then they are concentrated by centrifugation, which can damage the cells. The new devices described herein, however, allow initial accumulation of cells in a small volume (e.g., 0.5 milliliters) followed by addition of newly sorted cells to essentially the same small volume as most entering buffer passes out through the walls of the device; real-time concentration. Harvesting of cells after counter-streaming centrifugation similarly can benefit from a device providing real-time concentration in a continuous mode.

Devices such as those disclosed herein also can be used in a batch mode. In small-scale cell culture, for example, cells are harvested from dishes or bottles, after adding small amounts of enzymes or chemicals to release the cells if necessary, and later transferred into centrifuge tubes for concentration, washing, and further use. In some cases the spent medium also is harvested. The new device can rapidly separate cultured cells from spent medium and concentrate them in a minimal volume, after which additional medium could be placed into the device, the cells resuspended by inversion and thereby washed, and the cells again concentrated—all with minimal stress on the cells.

In certain applications, the solid lower end of the device might be filled, before placing cells in the device, with a medium favorable for rehabilitation of the cells after the rigors imposed upon them, be they physical or biochemical, and all of the initial solvent rapidly replaced as cells were relocated into the favorable medium for rehabilitation and further use. This approach is applicable with both continuous or batch processing. In other embodiments, the device can maintain asepsis or provide biocontainment while concentrating, washing or storing cells.

The device may be used for the concentration of cells or particles. In a typical procedure, a suspension of cells or particles is placed in an appropriate medium or solvent and the combined material is placed into the interior of the inner vessel of the cell concentrator. The medium or solvent then is allowed to pass through the active wall of the cell concentrator, and the suspension is removed from the interior of the inner vessel when a desired concentration is achieved.

The device may also be used for the washing of cells or particles. In a typical procedure a suspension of cells or particles is placed in an appropriate medium or solvent and the combined material is placed into the interior of the inner vessel of the cell concentrator. The medium or solvent then is allowed to pass through the active wall of the cell concentrator. An appropriate cleaning medium or solvent is added to the interior of the inner vessel of the cell concentrator. The suspension of cells then is mixed with the cleaning medium or solvent. The cell concentrator may be inverted or other means may be employed to ensure mixing. The cleaning medium or solvent then is allowed to pass through the active wall of the cell concentrator. The steps of adding cleaning medium or solvent, mixing and allowing cleaning medium or solvent to pass through the active wall may be repeated as appropriate. The suspension is removed from the interior of the inner vessel when washing has been completed and a desired concentration has been achieved.

Examples provided herein illustrate a few of the many uses in cell biology or life sciences, but similar examples could be drawn from other areas in the physical sciences or industrial areas. Uses for the new devices are not claimed herein, because most if not all uses of such devices would be considered as non-inventive and not novel. Individuals skilled in the arts of cell or particle separation will understand that this device has many uses and facilitates or enhances many and diverse procedures.

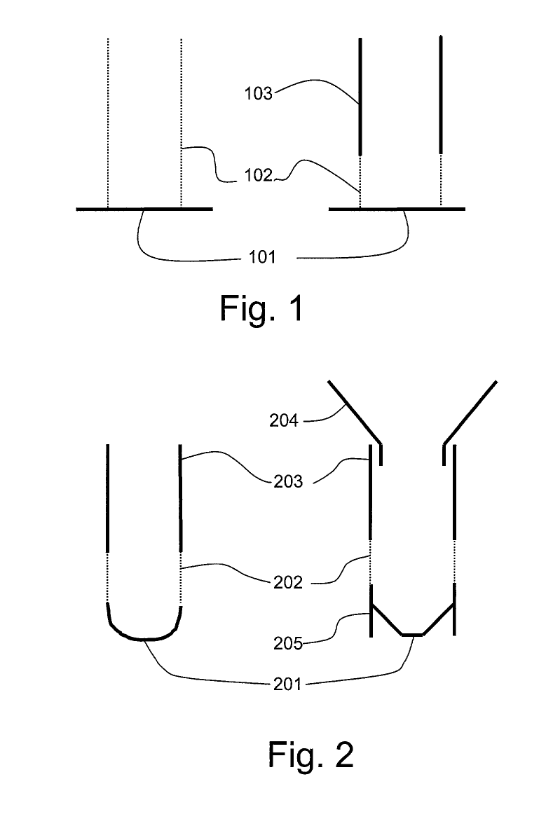

The Figures represent three-dimensional constructs and illustrate, in vertical or horizontal cross-sections, or an external view, how the elements essential to the device, namely the solid base (101, 201, 301, or 401) and active-wall (102, 202, 302, or 402) can be assembled in a construct and how function of the device can be enhanced by including other elements such as a solid-upper wall (103, 203, 303, or 403), funnel-like extension (204), vacuum-assist chamber or base (415), or absorbent material (408). Alternative designs or approaches for fabrication are illustrated. A porous material may be bonded to the exterior surface of the capillary-pore membrane to offer support. Polyester or polypropylene may be used in this porous material. All dimensions, volumes, and diameters of pores in the active-wall can be changed as appropriate for the use. Elements shown in FIGS. 1 to 4 can be interchanged in fabrication of any given device.

FIG. 1 shows a vertical section through a simple device (left) with the two minimal elements, namely a flat solid lower end (101) and a more or less vertical active-wall (102) formed from a capillary-pore membrane. Another embodiment (right) adds a solid-upper wall (103) to facilitate similar separations while incorporating less membrane into the active-wall (102).

FIG. 2 shows a vertical section through a simple device (left) with a cup-like solid lower end (201), an appropriately sized active-wall (202) formed from a capillary-pore membrane, and an optional solid-upper wall (203). An alternative configuration for the device has a conical solid lower end (201) with a supporting skirt (205), an appropriately sized active-wall (202) formed from a capillary-pore membrane, a solid-upper wall (203), and an optional and separate funnel-like extension (204) to facilitate placement of the cell suspension into a relatively small device.

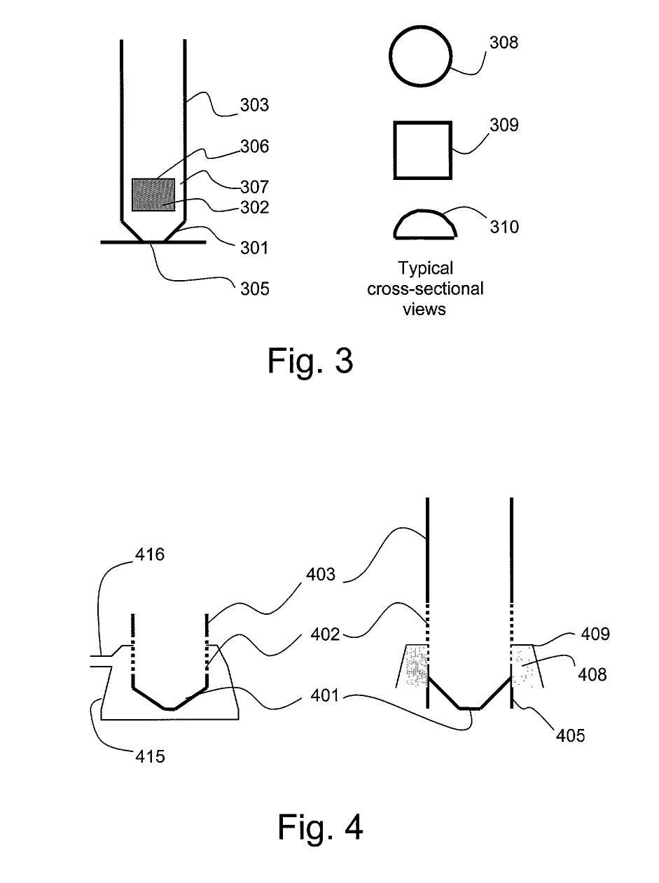

FIG. 3 shows an external side view of a device (left) useful for certain applications. The device might have one or more windows (306) of appropriately sized active-wall (302), formed from a capillary-pore membrane, and supported by a continuation (307) between the conical solid lower end (301) and solid-upper wall (303). In this embodiment, a support (305) holds the construct in a vertical position. Constructs as depicted in FIGS. 1-4 can have any appropriate cross-sectional design, and several cross sections (308, 309, 310) are illustrated (right).

FIG. 4 shows vertical sections through devices which provide assistance to move solvent through the active wall via a slight vacuum (left) or an absorbent matter (right). The vacuum base (415) with port (416) to attach a vacuum source can be fabricated as a separate construct into which the construct forming the active portion of the device (e.g., 402 plus 401 and optional 403) is positioned, as small leaks are not a problem. Alternatively, all can be fabricated as a single construct. The other device (right) includes an absorbent layer (408), such as polyethylene glycol or other materials as known to those skilled in the art, positioned in contact with the outer surface of all or part of the appropriately sized active-wall (402). Optionally, the absorbent material can be protected from much of the solvent flowing through the device by a roof (409). The devices illustrated have a cup-like or conical solid-base (401) and a solid-upper wall (403).

Elements of the Invention

a) Placement of a membrane with a smooth inner-facing surface and transmembrane pores of uniform diameter (e.g., 0.03, 0.8, 3.0 or 20 micrometers, or other as desired, with >80% within ±15% of nominal diameter) in a more or less vertical position extending upward from a solid lower end or base, as part of a three-dimensional construct with a solid lower end designed to collect the concentrated cells in a predefined volume without the need for centrifugation.

b) Occlusion of pores in said membrane filter with methylcellulose or other material as known to those skilled in the art to aid in overcoming surface tension, and facilitate transmembrane flow of water, or other solvent, as the methylcellulose dissolved or eroded to provide a “wick” to draw out water into and through said pores in said membrane.

c) Optional inclusion in the device of a means to increase rate of transmembrane flow of solvent through the active wall of said device by application of a slight, and possibly intermittent, vacuum on at least part of the active wall; or placement of polyethylene glycol or other material known to those skilled in the art to absorb solvent as appeared on the outer surface of the active wall.

Experimental Procedures

In the course of testing gated-pore membranes, as taught in U.S. Pat. No. 5,261,870 and U.S. patent application Ser. No. 60/168,953, we observed that water did not pass through capillary-pore polyester membrane stock (i.e., RoTrac® membrane; Oxyphen AG, as supplied) with pore diameters between 0.4 and 10 micrometers unless the hydrostatic head was greater than approximately 3 centimeters. However, pretreatment of the membrane with appropriate amounts methycellulose, as taught in U.S. Pat. No. 5,261,870, altered properties of test device so that water rapidly flowed through the membrane with a hydrostatic head of <2 centimeters. Once initiated, some flow occurred with hydrostatic heads of <0.5 centimeters.

We consider it likely that a hydrostatic head of greater than approximately 3 centimeter was necessary to overcome the combined “blocking action” of air within the capillary pores plus surface tension of water at the opening of the tunnel-like pores. It is well known (Meyers, 1988) that movement of materials across solid surfaces, or through pores, is affected by surface tension features. Surface tension differences between vapor, solid, and liquid have large effects on flow properties. The resultant resistance to flow is especially noticed with flow of liquids through capillary networks. One critical descriptor, contact angle, can be affected by use of surface active agents (Meyers, 1988; Adamson, 1990) to modify the contact angle from that of an untreated system to modify the pressures needed to induce flow through the capillary network. We reasoned that an alternative mode of assisting flow of solvent (e.g., water) through a capillary network, would be to fill the capillary network with a solid material methylcellulose (or other appropriate material). The methylcellulose becomes preferentially wetted, relative to materials constituting the walls of the capillary, and the wetted methylcellulose assists movement of water into the capillary network or pores. Subsequent dissolving or erosion of the solid material, leaves bulk solvent (e.g., water) water in the pores, rather than air, and allows continual movement of solvent through the pores. We found that such use of methyocellulose allowed initiation of transmembrane flow at a lower hydrostatic pressure, presumably for the reasons given above.

We recognized that this observation and positioning such membranes vertically could provide a family of devices with which a cell suspension could be concentrated at unit gravity, provided the desired calls were larger than the capillary pores and the desired cells or smaller cells did not occlude the capillary pores. In fact, concentration of a cell suspension with devices as described herein is faster than possible by conventional sedimentation. This is because the downward movement of cells is not dependent solely on their negative buoyant density at unit gravity, but is largely a result of downward flow of fluid, carrying the cells downward, to the active-face and out through the micropores. Thus, devices as disclosed herein can provide sedimentation velocities of centimeters per hour or even centimeters per minute, rather than millimeters per hour.

Initial tests with simple cylindrical constructs fabricated from RoTrac® membrane with pore diameters of 0.2, 0.4, 0.6, 0.8, 1.0 micrometers, and later 3.0 or 5.0 micrometers, processed (as taught in U.S. Pat. No. 5,261,870) with methylcellulose, revealed that practical rates of concentration could be obtained, with the cylinder positioned vertically, and that most cells moved downward in the remaining solvent and few cells adhered to the wall above the remaining fluid. This device operated without use of centrifugal force, essentially at unit gravity, and will run unattended. Under certain conditions (e.g., sufficiently large pore diameter, pre-filling of the capillary pores with a solvent with lower surface tension than the solvent to be used during cell concentration, or pre-filling of the capillary pores under pressure with the solvent ot be used during concentration), the capillary-pore membrane used in this device need not be pre-treated with a naturally occurring or synthetic polymer.

The present disclosure and claims teach devices using either stock membranes as supplied by vendors or specially processed membranes as taught in U.S. Pat. No. 5,261,870 and Ser. No. 60/168,953. Further, this invention is not limited to use of capillary-pore membranes or membranes or filters with any specific pore or mesh size. As detailed in the examples, we fabricated constructs of various types, and this invention includes any device using one or more elements claimed herein and is not limited by the materials used to fabricate the construct or any specifics of the construct, including the active-wall.

Each embodiment of the device is a construct including at least two elements. The first element is a solid lower end fabricated from impervious material, either flat or fabricated with a shape to facilitate collection of the desired cells in an appropriate volume. The second element is an “active-wall” extending upward from said solid lower end and providing an appropriate surface area with pores having a diameter appropriate for retention of the desired cells and outward passage of most smaller cells and outflow of solvent. An optional third element with a solid-upper wall, either fabricated in the same construct or as a separate slip-in unit, can extend upward to accommodate a larger volume of suspension. This third element can be one or more pieces to provide a solid-upper wall entry to the active-wall area, extend the device with a flared opening, or extend the device with a second sealed end, including a septum and optional air vent, to allow aseptic concentration of cells.

The preferred embodiment of the device has a small cup-like solid lower end fabricated from plastic and an active wall fabricated from capillary-pore (also termed track-etched) membrane rather than a microporous or fibrillar membrane. It might advantageously use membrane stock with a pore diameter approximately 0.6 to 0.8 times the diameter of the cells to be concentrated, although pore diameter must be selected somewhat empirically. It would be advantageous to process the membrane forming the active wall as taught in U.S. Pat. No. 5,261,870.

FIGS. 1 to 4 imply that the lower portion of this device might be similar to a typical laboratory cylinder, tube, or vial. However, there are many approaches and three-dimensional shapes that can be used to fabricate the construct(s) needed for this device. The examples in FIGS. 1 to 4 illustrate only a few of the many configurations that might be used to fabricate this device. The device can be fabricated in other constructs with other forms or shapes. Also, the device can incorporate other elements, such as the absorbent to control the final volume of the cell suspension (as in FIG. 4 right, or in any other manner) or an upper lid with a septum and possibly an air vent (not illustrated), etc. The invention is not limited by the nature of the construct, but rather by the principal of joining a vertical active-wall in combination with a solid lower end, with the active-wall formed from a smooth membrane with multiple pores of relatively uniform diameter.

### EXAMPLE 1

A cylinder approximately 1.7 centimeters in diameter and 4 centimeters high was fabricated from RoTrac® capillary-pore polyester membrane (0.8-micrometer diameter pores, laminated to 120 g/m² polyester-mesh backing) which previously had been processed with methycellulose (15% w/v in water) to plug the pores, as in U.S. Pat. No. 5,261,870. Pores in membrane stock processed in this manner were known to open rapidly after exposure to water at room temperature. The cylinder was attached to an acrylic plastic base, forming a construct similar to that depicted in the left portion of FIG. 1. Approximately 9 milliliters of water was rapidly poured into the construct. It was found that water started to seep through the active-wall (102) of the construct after 0.5 minutes. Flow was allowed to continue for 5 minutes. Then the construct was refilled (4 centimeters height) and the times for the water level to fall to 3.0, 2.0, 1.5 and 1.0 cm recorded. Average values for these successive intervals (three replicate observations) were 14, 17, 27, and 33 seconds. Based on these data, it was estimated that flow rate initially was 6.6 milliliters/minute and then slowed to 5.4, 3.6, and 2.8 milliliters per minute.

A similar construct was formed, except it used RoTrac® capillary-pore polyester membrane (1.0-micrometer diameter pores, laminated to 60 g/m² polyester mesh backing) to form a cylinder 2.0 centimeters in diameter and 4 centimeters high, providing the active-wall (102). Evaluations were as above. After the construct was refilled (4 cm height) it was estimated that flow rate initially was 36 milliliters per minute and remained at approximately 12 milliliters per minute as fluid fell from 1.5 to 1.0 cm.

### EXAMPLE 2

A slightly tapered cylinder (approximately 1.7 cm diameter at the top, 1.4 cm at bottom; 4.0 cm high) was prepared as above using RoTrac® capillary-pore polyester membrane (0.4-μm diameter pores, laminated to 60 g/m² polyester mesh backing) and attached to a hemispherical solid lower end (cut from a polycarbonate tube) to form a construct similar to that in the left portion of FIG. 2. Total height of the construct was 5.5 centimeters, the upper-wall was 2.5 centimeters high, the active wall was 1.7 centimeters high, and the solid lower end was 1.3 centimeters high. The external face of the construct was wet by immersion in water, insuring that none entered the construct, and briefly blotted. Approximately 10 ml of water was rapidly poured into the construct and it was observed that the water level started to drop within 0.5 minutes. Flow was allowed to continue for 3 minutes. Then the construct was refilled (to 5.5 cm) and the times for the water level to fall to 4.5, 3.5, and 2.5 centimeters (3, 2 and 2 milliliters outflow) were recorded; values were 50, 130, and 385 seconds. Based on these data, it was estimated that flow rate initially was 3.6 milliliters per minute, but was reduced to <0.5 milliliters per minute as fluid fell from 3.0 to 2.5 centimeters.

### EXAMPLE 3

A construct as shown in FIG. 2 right (without funnel) was fabricated using RoTrac® capillary-pore polyester membrane (0.8 micrometer diameter pores, laminated to 60 g/m² polyester mesh backing) for the active-wall (202), which was 2.0 centimeters high and had a perimeter of approximately 5 centimeters. Total height of the device was approximately 10.6 centimeters. It was filled with a physiological salts solution which was poured out after 1 minutes. The solid-base then was filled with 4 milliliters of egg-yolk-Tris extender, as known to those skilled in the art of sperm preservation, using a pipette. The device was filled with 11 milliliters of a suspension of bull sperm in the same salts solution, layered on top of the egg-yolk-Tris extender. A portion of the initial suspension was saved for later determination of sperm concentration. In two replicate runs, it required 12 and 10 minutes for 11 milliliters to flow out, an overall rate of approximately 1.0 ml per minute. A small pipette was used to mix the suspension in the solid base and the suspension then was aspirated and transferred into a tube. Aliquots of both the initial and final suspensions were appropriately diluted and sperm concentration determined by counting the cells in hemacytometers using a phase-contrast microscope. Based on 2 replicate tests, 100 and 85% of the sperm initially present were recovered and concentration was increased >3 fold from 41 to 128 or 105 to 312×10⁶ sperm per milliliter. Recovery of cells was satisfactory, with an active-wall having 0.8-micrometer diameter pores in a device of this design. Although the overall flow rate was approximately 1 milliliter per minute, for certain applications this might be too slow.

### EXAMPLE 4

To evaluate utility of the device to concentrate and wash cultured cells, a device similar to that shown in FIG. 2 (left) was used. The construct has a himispherical lower-end approximately 1.6 centimeters in diameter, an active face approximately 5 cm in perimeter and 1 centimeter high, and the solid upper wall extended approximately 4.5 centimeters above the active face. The active face was fabricated from RoTrac® capillary-pore polyester membrane with pores 3 micrometers in diameter (laminated backing was 60 g/m² polyester mesh), which were plugged with methylcellulose as above. The cells were cultured mouse myeloma cells, approximately 6 micrometers in diameter, which had been grown in a culture flask by procedures known to those skilled in the art. Without prior wetting of the construct, 9 milliliters of a cell suspension were poured into the device. Fluid started to flow through the active wall 0.28 minutes later. The times for level of fluid in the tube to fall by 1, 2, 3, or 4 centimeters were recorded, and were 1.21, 4.12, 12.4 and 43.3 minutes. Flow of medium out of the device was estimated at 1.5 ml initially and 0.05 ml per minute as the level approached the upper edge of the active wall. Then, a small pipette was used to mix the suspension in the solid base (approximately 1.7 ml) and the suspension then was aspirated and transferred into a tube. Aliquots of both the initial and final suspensions were appropriately diluted and cell concentrations determined by counting the cells in hemacytometers using a phase-contrast microscope. Concentration in the initial suspension was 156×10⁶ cells per milliliter and in the final suspension it was 740×10⁶ cell per milliliter. Concentration had been increased 4.7 fold.

### EXAMPLE 5

Similar studies with a device identical to that described in EXAMPLE 4, except that the active-wall had pores of 5 micrometers diameter, rather than 3 micrometers, revealed that flow rate was substantially lower. Fluid started to flow through the active wall in 0.27 minutes. However, the times for level of fluid in the tube to fall by 1, 2, 3, or 4 centimeters were 2.27, 9.45, 33.21, and 72.3 minutes. After approximately 4 milliliters had flowed out through the active face, estimated flow was approximately 0.07 milliliters per minute as compared with 0.2 milliliters per minute for the device with 3-micrometer pores of EXAMPLE 4. This difference in flow rate likely is because the diameter of the cells, approximately 6 micrometers, was too close to the diameter of the pores in the active-wall and the cells tended to “hang up” on the pore openings.

### EXAMPLE 6

A device similar to that used for EXAMPLE 4 (i.e., FIG. 2 left), but with an active-wall approximately 2 centimeters high (RoTrac® capillary-pore polyester membrane with pores 3 micrometers in diameter; laminated backing of 60 g/m² polyester; pores initially occluded with methylcellulose) and without a solid upper wall was used to collect cells leaving a flow sorter (Coulter Model Elite-ESP; equipped with 488 nm argon ion laser). The cells were cultured mouse myeloma cells, approximately 6 micrometers in diameter. The suspension was approximately 150×10⁶ cells per milliliter. The sorter was operated, as known to those skilled in the art, with the cells gated on the basis of light scatter so that only live cells would be discharged into the cell concentrator device. Further, the drops immediately before and after each drop containing a living cell (a three drop sort envelop) also was discharged into the concentrator device, so that the rate of accumulating fluid would be greater. Without wetting the construct, the stream containing live cells was collected for 30 minutes, at which time the cell concentrator was full; 2.7 ml remained in the device. Then the discharge stream was collected into a series of solid tubes for the next 30 minutes and 10.5 milliliters accumulated. Comparing the values of 2.7 and 10.5 milliliters, 74% of the fluid discharged from the flow sorter passed out through the active wall of the cell concentrator device in “real time”, without allowing any outflow after removal of the device from the cell sorter. Concentration of cells was >3.5 times greater with use of the cell concentrator than a conventional plastic tube. At the time of initial sorting, >96% of the cells diverted to the collection tubes were live. Cells collected in the cell concentrator device were re-analyzed approximately 45 minutes later and 97% of the cells still were live, based on light scatter.

### EXAMPLE 7

From EXAMPLE 3, it was evident that for concentration of small cells (e.g., bull or other mammalian spermatozoa) requiring use of an active-wall with pores <2 cm, reliance on gravity and a hydrostatic head of <2 cm might be inadequate. FIG. 4 depicts two devices that circumvent that limitation. One (left) allows constant or intermittent application of a slight vacuum to the outer face of the active-wall and the other (right) allows positioning of a hygroscopic material against the active-wall.

A device as in FIG. 4 left was fabricated as in EXAMPLE 4, except that the active wall was surrounded by a vacuum base (415). An aquarium pump was used to intermittently apply a low vacuum to the active-face. Flow rate was substantially increased (by at least two fold), even when fluid was just above the active-wall. The device is appropriate for certain applications, and the device in FIG. 4 right should be similarly effective.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

We claim:

1. A cell concentrator, comprising:
a solid lower end; and
an active wall, having an interior surface and an exterior surface, extending upward from the solid lower end, forming, in conjunction with said active wall, an inner vessel, said inner vessel having an interior, said active wall having a plurality of pores providing communication between the interior of the active wall and the exterior of the active wall, said pores being configured to facilitate liquid flow therethough.

2. The cell concentrator of claim 1, further comprising an outer container forming an outer vessel, partially enclosing and exterior to said inner vessel, configured to receive liquid passing through the active wall.

3. The cell concentrator of claim 1, further comprising an impermeable upper wall extending upward from the active wall.

4. The cell concentrator of claim 1, wherein the active wall comprises a capillary-pore membrane having an interior surface and an exterior surface.

5. The cell concentrator of claim 4, wherein the capillary-pore membrane contains polyester.

6. The cell concentrator of claim 4, wherein the exterior surface of the capillary-pore membrane is bonded to a porous supporting material.

7. The cell concentrator of claim 1, wherein the pores have diameters within the range from about 0.03 micrometers to about 20 micrometers.

8. The cell concentrator of claim 1, wherein the pores have diameters within the range from about 5 micrometers to about 20 micrometers.

9. The cell concentrator of claim 1, wherein the pores have a diameter within ±15% of a stated diameter.

10. The cell concentrator of claim 1, wherein the pores have a uniform diameter throughout their lengths.

11. The cell concentrator of claim 1, wherein the pores have pore surfaces between the interior of the active wall and the exterior of the active wall, and wherein the pore surfaces carry charges.

12. The cell concentrator of claim 1, additionally comprising an absorbent layer in contact with the exterior surface of the active wall.

13. The cell concentrator of claim 1, wherein the materials used to configure the pores are selected from the group consisting of cellulosics, polyvinylpyrrolidone, polyvinylalcohol polymers, polysaccharide crystals, surfactants, detergents and amyl alcohol.

14. The cell concentrator of claim 1, wherein the active wall is constructed from a material selected from the group consisting of cellulose, cellulose esters, nitrocellulose, polyvinylidene difluoride, polytetrafluoroethylene, nylon, polyethylene, polypropylene, polycarbonate, polyester, and silver.

15. A method for concentrating cells, comprising:
a) placing a suspension-containing solvent and cells into the interior of the inner vessel of the cell concentrator of claim 1;
b) allowing solvent to pass through the active wall; and
c) removing suspension from the interior vessel when a desired concentration of said cells is achieved.

16. A method for washing cells, comprising:
a) placing a suspension-containing solvent and cells into the interior of the inner vessel of the cell concentrator of claim 1;
b) adding a cleaning solution to the interior of the inner vessel of the cell concentrator of claim 1;
c) allowing cleaning solution and solvent to pass through the active wall; and
d) removing suspension from the interior of the interior vessel when washing of said cells is accomplished.

17. A cell concentrator, comprising:
a solid lower end;
an active wall, having an interior surface and an exterior surface, extending upward from the solid lower end, said solid lower end and said active wall forming, in conjunction, an inner vessel, said inner vessel having an interior, said active wall having a plurality of pores providing communication between the interior of the active wall and the exterior of the active wall, said pores being configured to facilitate liquid flow therethough;
an outer container forming an outer vessel, partially enclosing and exterior to said inner vessel, configured to receive liquid passing through the active wall; and
an impermeable upper wall extending upward from the active wall.
